(19) United States
(12) Patent Application Publication
(10) Pub. No.: US 2006/0014496 A1
(43) Pub. Date: Jan. 19, 2006

(54) System for in-band and near-band interference mitigation

(76) Inventor: Arik Klein, Rishon Lezion (IL)

Correspondence Address: TEXAS INSTRUMENTS INCORPORATED, P O BOX 655474, M/S 3999, DALLAS, TX, 75265, US

(21) Appl. No.: 11/183,595

(22) Filed: Jul. 18, 2005

Related U.S. Application Data
(60) Provisional application No. 60/589,181, filed on Jul. 19, 2004.

(51) Int. Cl. H04B 1/00; H04B 15/00

(52) U.S. Cl. 455/63.1

(57) ABSTRACT

The present invention provides a system for mitigating deleterious interference effects on a wireless LAN system (100). An access point is adapted to monitor communications for an interference condition (104, 106). Some desired time threshold is provided. The access point is adapted to alter an operational characteristic responsive to an occurrence of the interference condition, and maintains that altered operational characteristic until the desired time threshold has passed. The access point is then returned (110, 114) to an original operational state after the desired time threshold has passed and the interference condition has ended.

### PRIORITY CLAIM

This application claims priority of U.S. Provisional Application No. 60/589,181, filed Jul. 19, 2004.

### TECHNICAL FIELD OF THE INVENTION

The present invention relates generally to the field of digital voice and data communications and, more particularly, to a versatile system, comprising various constructs and methods, for mitigating deleterious adjacent channel and narrow band interference effects on digital communications.

### BACKGROUND OF THE INVENTION

The escalating deployment of wireless networking technology as well as other wireless technologies in the same unlicensed spectrum is rapidly increasing the radio frequency (RF) interference for Wi-Fi® (802.11) products, threatening the data throughput performance of wireless local area networks (WLAN). At the same time, the market is demanding higher data throughput rates for new WLAN applications like multimedia audio and video, streaming media, voice over WLAN, and others that require quality of service (QoS) capabilities and low packet error rates. As a consequence of an increasing amount of in-band and adjacent band interference in the environment for WLAN equipment, the design of radios and digital filtering has become critical.

WiFi and WLAN systems generally rely on a variety of modulation and multiplexing schemes to improve data reliability and error recovery. For example, Orthogonal Frequency Division Multiplexing (OFDM) is a modulation scheme commonly used in 802.11 systems to organize or allocate data transmissions. Often, OFDM and other modulation schemes divide a given transmission frequency range into multiple, narrow sub-bands. This narrowing of bands renders those bands more susceptible to deleterious effects of in-band interference (e.g., carrier wave interference) from overlapping non-802.11 systems, and to adjacent channel interference other 802.11 systems or devices.

Depending upon the nature and duration of interference events, system operations can be degraded or even stalled in a number of ways. For instance, certain narrow band interference events can cause false triggering of transmit/receive control parameters. Depending upon the duration of the narrow band interference event, stalling or blocking of transmissions or receptions may continue indefinitely.

As a result, there is a need for a system that addresses and minimizes the deleterious effects of in-band and adjacent band interference in WLAN systems and operating environments, while providing efficient and reliable communications in an easy, cost-effective manner.

### SUMMARY OF THE INVENTION

The present invention provides a versatile system, comprising various constructs and methods, for mitigating deleterious effects of in-band and adjacent band interference events in WLAN systems and operating environments. The present invention provides a versatile system that is compatible with a wide variety of coding, multiplexing and correction schemes.

Specifically, the system of the present invention detects the occurrence of an interference event while a system is operating in certain transmit/receive modes. Once such an event is detected, the operational mode of the system is shifted to a mode that is either immune or less susceptible to the interference. The continued occurrence of the event may be monitored to determine when the event ends. Once the event has ended, the operation of the system may be shifted back to its original mode.

More specifically, various embodiments of the present invention provide a system for mitigating deleterious interference effects, both from ACI and NBI, on a wireless LAN system. An access point is adapted to monitor communications for an interference condition. Some desired time threshold, such as a timeout parameter, is provided or dynamically determined. The access point is alters an operational characteristic (e.g., parameters, operation mode) responsive to an occurrence of the interference condition, and maintains that altered operational characteristic until the desired time threshold has passed. The access point is then returned to its original operational state after the desired time threshold has passed and the interference condition has ended.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 provides an illustration depicting a state diagram illustrating certain aspects of the present invention;

FIG. 2 provides an illustration depicting a timing diagram of certain operations according to the present invention; and

FIG. 3 provides an illustration depicting a partial system diagram implementing certain aspects of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The present invention is hereafter illustratively described primarily in conjunction with the design and operation of a certain high-performance WLAN systems (e.g., 802.11(a)-(g)). Certain aspects of the present invention are further detailed in relation to specific operational modes and standards. Although described in relation to such constructs and schemes, the teachings and embodiments of the present invention may be beneficially implemented with a variety of digital communications technologies. The specific embodiments discussed herein are, therefore, merely demonstrative of specific ways to make and use the invention and do not limit the scope of the invention.

The present invention provides present invention provides a versatile system, comprising various constructs and methods, for mitigating deleterious effects of in-band and adjacent band interference events in WLAN systems and operating environments. The present invention provides a versatile system that is compatible with a wide variety of coding, multiplexing and correction schemes. Specifically, the system of the present invention detects the occurrence of an interference event while a system is operating in a certain transmit or receive mode. Once such an event is detected, the operational mode of the system may be shifted to a mode that is either immune or less susceptible to that source of interference. The continued occurrence of the interference event may be monitored to determine when the interference ends. Once the event has ended, the operation of the system may be shifted back to its original mode.

The increasingly ubiquitous nature of wireless communications technologies in the same unlicensed spectrum is rapidly increasing the amount of potential radio frequency (RF) interference for wireless technologies, such as 802.11-based systems. This increased interference threatens data reliability and transfer rates within affected systems (e.g., WLANs). At the same time, higher data throughput rates are needed for new WLAN applications—such as multimedia audio and video, streaming media, voice over WLAN, and others—that require quality of service (QoS) capabilities and low packet error rates. Thus, attention to in-band and adjacent band interference has become critical.

For purposes of explanation and illustration, the present invention is hereafter described primarily in reference to narrow band interference (NBI) and adjacent channel interference (ACD), as representative of in band and adjacent band interferences, respectively. Transmission problems stemming from NBI and ACI are gaining attention in a number of areas. For instance, the problem of ACI for Wi-Fi and WLAN in unlicensed bands has come to the attention of manufacturers, system designers, integrators and the Federal Communications Commission (FCC). As a result, the FCC recently increased the available transmission spectrum for 802.11 WLANs while noting that further regulatory changes may be needed in that band of the spectrum.

In conventional systems, the performance of a WLAN access point (AP) or client station can be interfered with by other WLAN APs and stations in close proximity to it, and by other non-802.11 devices which operate in the same unlicensed band. This situation is similar to that which the cellular telephone industry faced and solved with channel frequency reuse solutions. As 802.11 markets grow, however, and the density of WLAN technology increases, the problem will be exacerbated in a number of system applications (e.g., enterprise deployments, dense commercial hot-spot deployments, high density urban deployments).

The performance of a given WLAN system can be adversely affected by a number of sources of interference (e.g., cordless phones, Bluetooth™ personal area networking devices, microwave ovens). Interference can emanate from adjacent channels. In such situations, an 802.11 system's RF sub-system and digital filtering can greatly affect the performance of an AP or station. Moreover, physical topology or design of a WLAN network can also greatly impact the effect of in-band interference.

Performance of a WLAN system is often evaluated in terms of signal-to-interference ratio (SIR)—which is defined as the ratio of the data signal to the interference signal. Frequently, SIR is usually more critical to WLAN performance than signal-to-noise ratio (SNR). Signals generated by commercially available wireless equipment have certain inherent imperfections. For example, signals from 802.11 radios generate some amount of energy outside of their approved spectrum band. This phenomenon is known as side band emissions. Other wireless devices and systems—such as Bluetooth, cordless telephones, and others that occupy the same transmission band as 802.11—also exhibit such behavior. Typically, filtering is used to minimize RF interference from adjacent channels. However, this interference generates side lobe energy that falls into the pass band of 802.11 WLAN signals. If ACI is much stronger than an 802.11 signal, side band energy from the ACI can dominate the channel's noise floor.

In-band interference can also have a limiting, or even debilitating, effect on a WLAN's RF links. For illustrative purposes, interference caused by two 802.11 access points may be considered, but similar discussion or analysis could similarly be applied to in-band interference from Bluetooth, cordless telephones or microwave ovens. Signal propagation losses for an 802.11 AP depend on the environment. Generally, signal loss is a function of distance from the AP to the user. Under ideal line-of-sight conditions, signal loss is proportional to the square of the distance therebetween. The range of a particular 802.11 AP usually also depends on several other factors, including the AP's transmit power (e.g., 20 dBm), antenna gain, and the sensitivity of a receiver for a certain modulation. When two sources of RF signals, such as two APs, are placed in close proximity to one another, thermal noise and path losses become secondary considerations because in-band interference has a dominant impact on the effective range and data rates of the APs. In-band RF interference can thus render an AP ineffective over a large portion of its coverage area—yielding a profound performance degradation. For example, an AP using packet binary convolutional coding (PBCC) modulation or OFDM may experience a reduction in its effective range by a factor of ≧20, as a result of in-band interference.

At this point in time, in-band RF interference from one AP to another is typically not a frequent occurrence. Relatively few 802.11 WLANs are deployed and, since most applications require little WLAN bandwidth, errors during transmissions are usually recovered very quickly. As WLAN technology becomes more pervasive, however, and higher bandwidth applications requiring QoS capabilities increase in popularity, in-band interference will increase as well. For example, in-band interference generated by 802.11 technologies could become acute in high-density offices, and dwellings like town homes, condominiums and apartments.

Comprehending these issues, the present invention registers the occurrence of an interference event—either ACI or NBI—while a system is operating in a certain transmit or receive mode. Once an event is detected, the present invention shifts the operational mode of the system to another operational mode that is less susceptible—or even immune—to that source or type of interference. The existence of the interference event may be monitored to determine when it ends. Once the event has ended, the operation of the system may be shifted back to its original mode.

For purposes of explanation and illustration, certain aspects of the present invention are now described in greater detail, in relation to certain illustrative embodiments utilizing 802.11 (a), (b) or (g) protocols. Various constructs and methodologies are described, in some cases, by reference to certain standard or optional system signal or memory constructs (e.g., specific register or interrupt names. It should be understood, however, that the teachings of the present invention may also be applied utilizing other suitable constructs or to other WLAN and wireless communication applications.

As previously noted, WLAN systems utilize a number of multiplexing, modulation and error correction schemes. Depending upon which schemes are used, and upon various design characteristics, a system may be more vulnerable to disruption by a particular type of interference event.

Certain WLAN components or systems, for example, may utilize an OFDM scheme based on an autocorrelation detection method. Such a method has advantages in overcoming multi-path problems, but it may also increase a system's susceptibility to locking on ACI signals. In some systems, once such an ACI effect occurs, the effect continues or builds if the system does not have a mechanism for quickly detecting and aborting ACI packets. Where this is the case, the ACI may consume the full transmission resources of the system, preventing it from performing valid transmission and reception. This result may be more noticeable or prevalent where the ACI in question is of higher power or closer in offset frequency.

Other WLAN components or systems may be particularly sensitive to NBI—such as, for example, carrier wave (CW). The potential degradation from this is significant, due to the continuous nature of this type of interference. Depending upon the design of a device or system, and the relative magnitude of its bands or sub-bands, NBI may be especially problematic if it occurs at critical offset intervals. Where such NBI occurs, it can interfere with device performance in a number of ways. For example, NBI may cause a component to falsely trigger an indication that a particular transmission or operational activity (e.g., interrupts) is occurring—precluding the component from performing other valid functions.

In certain embodiments of the present invention, ACI events are addressed in system firmware, by adding a sequence in a Receive Mode (Rx) PHY header interrupt handler that detects and aborts ACI packets. In such a manner, a WLAN component may overcome an ACI event and resume its normal Rx and Transmit Mode (Tx) operations in a relatively short amount of time (e.g., ˜30 μsec). Further compensation may be provided, by adjusting certain component operational parameters until the ACI event has been overcome. For example, in one embodiment, ACI packets rate may be measured. If that rate is above a desired threshold value, an energy detection (ED) parameter may be disabled while a packet detection (PD) threshold is increased—thereby reducing the component's clear channel assessment (CCA) sensitivity. Depending upon the desired system operation, a restore operation may be performed after some predetermined time interval, or in response to some dynamic monitoring. For example, after a predetermined time interval (e.g., 3 minutes, 5 minutes), an AP may be adapted to restore its default ED and PD values if the ACI event is over—or to repeat the listed process if the ACI event continues.

In certain embodiments of the present invention, NBI events may be addressed by switching operational mode of an AP. For example, if a system component detects a stuck condition (e.g., beacons-stuck, Tx-stuck), and the AP is 802.11 (b)/(g) mode (i.e., mixed mode), then the AP may be prompted to switch to (b)-only mode, without going through a recovery or reboot process. The switch to (b)-only mode is prompted since it is stable under NBI conditions. Depending upon the desired system operation, a restore operation may be performed after some predetermined time interval, or in response to some dynamic monitoring. The stuck condition(s) may be monitored or evaluated for some predetermined interval and, if the condition(s) continue, then a recovery process may be initiated. After being in (b)-only mode for some predetermined time interval (e.g., 3 minutes, 5 minutes), the an AP may be adapted to return to mixed mode the NBI event is over—or to repeat the listed process if the event continues.

In some embodiments, the above-described operations may be provided inter-operatively. For example, when either beacon/Tx stuck condition or ACI is detected, the AP may be adapted to attempt to set ED off and PD to an increased threshold, prior to switching to (b)-only mode. Depending upon the system configuration and operating conditions, such an approach may be sufficient to recover from the NBI (i.e., beacons/Tx stuck condition terminates).

In other embodiments, the shifting or changing of operational mode may be provided in some other suitable form. For example, if the system component is operating in 802.11 (a) mode, switching to (b) mode may not be a valid option. 11 B mode is not a valid option. In these instances, the AP may be adapted to, for example, switch LNA off or switch to another channel.

Specific implementations of the embodiments referenced above are now provided in relation to a specific WLAN device, for purposes of illustration and explanation. ACI events may be addressed by providing a packet abort function in system firmware (FW)—for example, in the context of an Rx-PHY Header interrupt handler. This packet abort function detects, counts and aborts each ACI packet that generates this interrupt. By aborting ACI packets, an affected WLAN component may be freed to process other Rx or Tx packets, instead of processing the invalid ACI packets until completed.

An ACI packet may be registered in the presence of two conditions: PHY-Rx controller-state indicates Rx of OFDM packet data part (i.e., bits 12-15 of PHY-register Ox201F are above 6); and a current value of FFTP-correlation-peak (i.e., 9 LS bits in PHY register Ox2011) is under a configurable threshold ACI-FFTP Threshold (e.g., default=Ox50). Detections are counted in order to report the driver when requested.

It may be useful or necessary to check certain conditions before aborting ACI packet(s). Packet duration may be confirmed as meeting or exceeding a desired threshold (e.g., ˜30 μsec) by evaluating PLCP length/rate. Aborting a relatively short packet may damage a subsequent valid packet. A check to ensure that calibration is not in progress may be performed, to avoid conflicting access to identical registers (i.e., avoid ACI abort during calibration). A check to ensure that there is no pending Rx-Complete interrupt may also be performed. This condition may indicate that a current PHY-Header interrupt is served before a previous packet Rx-Complete interrupt. Running an ACI abort may therefore drop the previous packet.

When all requisite conditions are met, ACI packets are aborted. One illustrative embodiment of a pseudo-code segment for performing such an operation is provided below:

(* Performed with interrupts disabled *)
RX_FREE_MEM=0; (* Clear RX_MBLK_VALID to ensure RX_FRM_PTR doesn't change when Rx Reset is applied *)
BBWrite(Ox2001, OxO); (* Disable PHY Rx *)
RX_RESET=1; (* Reset Rx path of RMAC *)
RX_FREE_MEM=(uint32)(CFG_RX_MBLK_VALID|MBLK_MAKE_HW_ADDR (memPools[POOL_RX].queue.head)); (* Restore RX_CURR_PTR and RX_FRM_PTR values as before the ACI packet was received *)
RX_RESET=0; (* Enable Rx path of RMAC *)
BBWrite(Ox2001, Ox1); (* Enable PHY Rx *).
   To avoid unnecessary Tx delays due to ACI packets, DIFS and Backoff timers may also be modified upon ACI packet detection as follows:

(* Performed with interrupts disabled *)
Reduce Backoff timer by desired threshold; (e.g., ˜30 μsec) (* to compensate for time loss due to the ACI packet *) (* for short slot reduce 3 slots, for long slot reduce 2 slots).
IF result<1, write 1 to timer; (* so at least one slot backoff is done to avoid collisions*)
Clear DIFS timer (* since ACI Rx reloads it *) (* done last abort sequence, so Backoff timer won't start counting earlier *).
   Unlike an abort sequence, this sequence is non-destructive, so it may be done for every ACI packet detection—i.e., only under the first two conditions, and regardless of the additional three conditions specified above.

In other ACI event occurrences, an AP may need to acknowledge a received packet, but an ACI packet may be received right between Rx end and Ack-Tx start. To prevent this scenario or any problems that may results, a one-time initialization may be performed to set the WLAN component to enter a Pre-Tx mode immediately after Rx is finished. This may be provided in FW initialization by, for example, setting bit 2 of CFG_ACM register. QoS settings override this, leaving it unaffected.

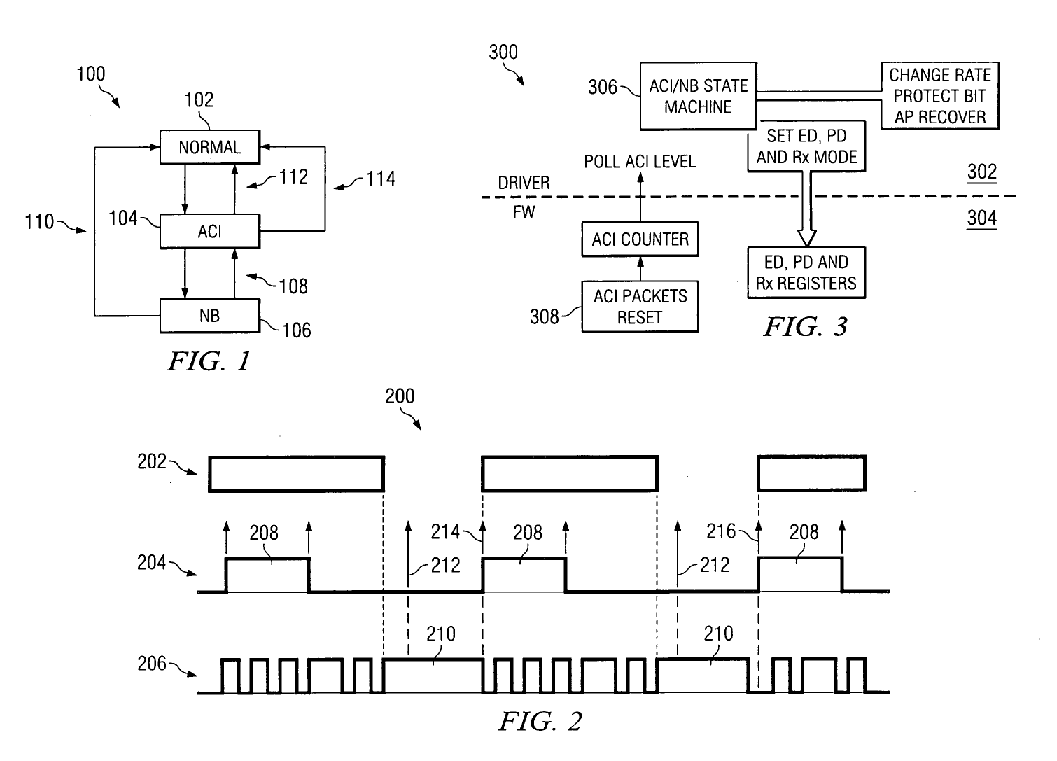

Referring now to FIG. 1, an illustrative state diagram 100 depicts various AP states and transitions under ACI or NB interference conditions, or Tx or Beacon stuck conditions. This state machine may be addressed within a driver. Diagram 100 depicts a Normal State 102 (INTERF_NORMAL_STATE). Upon initialization, and whenever there is no significant interference or stuck condition, an AP performs several functions. CCA ED is set as configured in energyDetection (default=On). CCA PD threshold is set to PacketDetectionUnderACILow. Dot11mode is set as configured (default-(b)/(g) mode).

Diagram 100 also depicts an ACI State 104 (INTERF_ACI_STATE). If either ACI or Beacons/Tx stuck is detected, the AP switches to this state and performs several functions. CCA ED is set to off. CCA PD's threshold is set to PacketDetectionUnderACIHigh, and Dot11mode is kept as configured.

Diagram 100 further depicts an NB State 106 (INTERF_NB_STATE). If Beacons/Tx stuck is detected, and the AP is in (g) or (b)/(g) mode, the AP switches to this state—unless an opt-out NBRecoveryMode is set to 0. Upon transition to this state, the AP may be adapted to perform several functions. The AP may switch to (b)-only mode, without reboot or recovery. In this instance, for Rx, this may be configured in HW (e.g., PHY register Ox2002 set to 11B-Ox2). For Tx, rate-management may be forced to use 11B rates only. Upon this switch, the current rate for each station is updated to the closest 11B rate below or equal to the current one. ERP protection bit may be set, in order to prevent collisions with 11G stations from other basic service sets (BSSs). In this instance, since OFDM is disabled, the OFDM PD may be ignored.

Diagram 100 further depicts an NB to ACI transition 108. This transition occurs after NBStateTimeout (e.g., 5 minutes) elapses since state 106 was entered. Upon initiation of transition 108, (b)/(g) mode is restored without AP reboot or recovery. For Rx, this may be configured in HW (e.g., PHY register Ox2002 set to 11B-Ox3). For Tx, a rate-management original (b)/(g) rates setting is restored. The ERP protection bit is also reset.

Diagram 100 further depicts an NB to Normal transition 110. This transition occurs if beacons/Tx stuck is detected in the NB state, and a MEDIUM_USAGE register indicates a usage time percentage below 75%. Upon this transition, an AP recovery is performed. The (b)/(g) mode is restored, without AP reboot or recovery. For Rx, this may be configured in HW (e.g., PHY register Ox2002 set to 11B-Ox3). For Tx, a rate-management original (b)/(g) rates setting is restored, and the ERP protection bit is reset. ED is set as configured in energyDetection (default=On), and PD threshold is set to PacketDetectionUnderACILow.

Diagram 100 further depicts an ACI to Normal upon Timeout transition 112. This transition occurs after ACIStateTimeout (e.g., 5 minutes) elapses since state 104 was entered. Upon this transition, ED is set as configured in energyDetection (default=On), and PD threshold is set to PacketDetectionUnderACILow. Diagram 100 also depicts an ACI to Normal upon Beacons/Tx Stuck transition 114. This transition occurs if beacons/Tx stuck is detected, the AP is in (a)-only or (b)-only mode, and the MEDIUM_USAGE register indicates a usage time percentage below 75%. If the NBRecoveryMode is set to 0, the transition may also be done for (g) or (b)/(g) modes. Upon this transition, an AP recovery is performed. ED is set as configured in energyDetection (default=On), and PD threshold is set to PacketDetectionUnderACILow.

Comprehending these operational states, the detection of ACI and NBI states is now described in greater detail. Under an ACI state detection construct of the present invention, FW may be adapted to count ACI packet detection events and provide this number to a driver. A driver-FW interface for monitoring this counter may be similar to, for example, the Windows® Software Package (WSP) ACI implementation (i.e., through a scratch pad register), or other implementations or methods as defined by give software (SW) requirements. The driver concludes an ACI condition if the reported number of ACI events per second crosses a configurable ACIRateThreshold (e.g., default=50). In other embodiments, this threshold may be dynamically adjusted according to valid traffic load, since more traffic results in less ACI detections. This may be implemented, for example, if FW also reports valid Rx-PHY Headers, and two or more different ACI thresholds can be used according to different traffic levels.

Under certain embodiments of an NBI state detection construct of the present invention, beacons/Tx stuck conditions are used for indirectly detecting and handling NBI, since NBI causes those conditions. In many systems, beacons and Tx stuck conditions detection mechanisms already exist in AP drivers. These mechanisms are combined with the ACI/NB state machine as described hereinafter.

In other embodiments of an NBI state detection construct of the present invention, direct NBI detection may be required. According to the present invention, direct NBI detection measures a percentage of time when CCA is on, but only during periods that don't include 802.11 valid activities. In these embodiments, FW is adapted to continuously maintain two values for the driver to read. The first is totalTimeFilter, which represents the total measurement time. The second is ccaTimeFilter, which represents the interference CCA time. The driver monitors these values, and estimates an interference level by dividing ccaTimeFilter by totalTimeFilter.

Referring now to FIG. 2, a timing diagram 200 is depicted to illustrate and explain certain aspects of this operation. Diagram 200 comprises three lateral timing plots: a measurement time plot 202, an events plot 204, and a CCA plot 206. Diagram 200 further comprises, along plot 204, several instances of interval 208, which is InterfCCAMeasurePeriod. The default value for InterfCCAMeasurePeriod is 20 ms longer than the longest valid packet. As depicted in Diagram 200, CCA timing is regularly measured over InterfCCAMeasurePeriod. Every valid 802.11 Rx or Tx activity 210 terminates a current measurement interval 208, and a new measurement interval 208 starts when an activity 210 ends. Under this operation, CCA-Measurement-Interval and CCA-On-Interval are monitored from MEDIUM_USAGE_TIME and MEDIUM_USAGE registers, respectively.

As noted above, CCA time during valid 802.11 activities is excluded from consideration. When a valid 802.11 Rx or Tx packet start is detected, a current interval measurement is taken. When that ends, a new measurement interval is started. Detection latency of a valid packet start (e.g., ˜20-30 μsec) is subtracted from the measurement preceding that packet. Rx start is detected upon PHY-Rx Header interrupt 212, but not an ACI packet. Rx end is detected upon either Rx-Complete interrupt 214, or upon timeout 216 that is measured from PHY-Rx Header according to the PLCP length/rate. Tx start is detected upon a Tx-Start interrupt. Tx end is detected upon a Tx-Stop interrupt. When a valid Rx or Tx packet ends, the MEDIUM_USAGE registers are read, to clear them for the next measurement interval—but the values read are disregarded.

In order to provide a continuous interference level estimation, a totalTimeFilter and a ccaTimeFilter are maintained. After every measurement interval, these filters are fed with MEDIUM_USAGE_TIME and MEDIUM_USAGE, respectively. These filters are implement: Filter[n+1]=NewMeasurement+a/b×Filter[n]. These a and b coefficients are selected such that b is a power of 2, and a equals b−1 (e.g., a=7, b=8). This provides an efficient shift implementation, instead of multiply and divide. Further, increasing a and b increases filter memory length. The precise values utilized may be determined through trial and error, calculation, or iteration to provide a desired behavioral trade-off (i.e., degree of stability versus degree of speed).

Given these operations, FIG. 3 provides a system diagram 300 depicting an illustrative embodiment of system architecture implementing the present invention. Diagram 300 depicts general architecture of ACI and NB functions of the present invention, in relation to driver 302 and FW 304 partitions of the system. As depicted, a state machine 306 runs in driver 302. State machine 306 is the state machine previously depicted in and described in relation to diagram 100. Machine 306 controls the relevant registers and operation modes—such as ED, PD, Rx-Mode values (i.e., (b) or (b)/(g)), Tx rate, ERP protection bit, and AP recovery mechanism. In setting the ED, PD and Rx-Mode values, a suitable SW interface is provided for direct register writing. FW 304 comprises an ACI reset sequence 308 for each ACI packet, in the context of the PHY-Rx Header interrupt handler. This updates the ACI counter that is available for driver monitoring.

As noted above, the system of the present invention provides a number of configurable parameters, accessible through a suitable configuration management utility or system. Such parameters may be loaded through a suitable interface into memory, set to take effect after an AP restart. Those parameter may include:
NBRecoveryMode: in this mode, Enable(1)/Disable (0) transition to INTERF_NB_STATE. If disabled, NB state is not entered (i.e. avoiding NB recovery transition to (b)-only mode). Default=1 (enabled);
ACIStateTimeout: this parameter defines the time to stay in INTERF_NB_STATE state before trying to return to INTERF_ACI_STATE state. Default=600 seconds, for example;
NBStateTimeout: this parameter defines the time to stay in INTERF_NB_STATE state before trying to return to INTERF_ACI_STATE state. Default=600 seconds, for example;
ACIRateThreshold: threshold for ACI state detection (i.e., to enter INTERF_ACI_STATE). Default=50, for example;
PacketDetectionUnderACILow: a reference value used for packet detection threshold in INTERF_NORMAL_STATE. Default=Ox90, for example; and
PacketDetectionUnderACIHigh: a reference value used for packet detection threshold in INTERF_ACI_STATE. Default=OxD5, for example.

A system according to the present invention may also provide a number of debugging and maintenance options. For example, upon ACI/NB state transition, a driver may record or report a new state, new ED or PD values, new Rx or Tx mode parameters, or an ERP protection bit. The level of ACI counters may be recorded or reported on regular intervals (e.g., every 1 sec), and some or all of these reports may be included in a system report level (e.g., RL_HAL=8).

Thus, within a WLAN system according to the present invention—particularly an 802.11 system—an AP automatically detects a high ACI rate condition, and adjusts ED and PD parameters accordingly. The AP attempts to return to normal state after ACIStateTimeout. The AP switches to (b)-only mode when necessary in order to recover from beacons/Tx stuck conditions that result from the NB interference. The AP returns automatically to (g) or (b)/(g) mode after NBStateTimeout, and stays there if NBI is over. No AP reboots or recoveries occur during these operations. Furthermore, an AP's recovery functionality in real beacons/Tx stuck conditions is preserved.

In all embodiments of the present invention, the constituent constructs, routines, functions or components may be implemented in a wide variety of ways—comprising various suitable software, firmware or hardware constructs, or combinations of thereof. For example, certain algorithms and routines described herein as firmware may also comprise separate code segments, grouped together in functional segments or incorporated as part of a larger integrated code segment. They may comprise software operating on a host computer system, or routines operating on a digital signal processor. Certain functions or operations may be provided in exclusively in hardware. All of these variations, and all other similar variations and combinations, are comprehended by the present invention. All such embodiments may be employed to provide the benefits of the present invention.

The embodiments and examples set forth herein are therefore presented to best explain the present invention and its practical application, and to thereby enable those skilled in the art to make and utilize the invention. However, those skilled in the art will recognize that the foregoing description and examples have been presented for the purpose of illustration and example only. The teachings and principles of the present invention are applicable to a number of digital communications technologies. The description as set forth herein is therefore not intended to be exhaustive or to limit the invention to the precise form disclosed. As stated throughout, many modifications and variations are possible in light of the above teaching without departing from the spirit and scope of the following claims.

What is claimed is:

1. A method of mitigating deleterious interference effects on a wireless LAN system, the method comprising the steps of:
providing an access point;
adapting the access point to monitor for an interference condition;
providing a desired time threshold;
adapting the access point to alter an operational characteristic responsive to an occurrence of the interference condition;
maintaining an altered operational characteristic until the desired time threshold has passed; and
returning the access point to an original operational state after the desired time threshold has passed and the interference condition has ended.

2. The method of claim 1, wherein the method further comprises the steps of:
determining whether the interference condition continues after the desired time threshold has passed; and
continuing to maintain, or further altering, the altered operational characteristic as long as the interference condition continues.

3. The method of claim 1, wherein the wireless LAN system comprises an 802.11-based communication system.

4. The method of claim 1, wherein the step of adapting the access point to monitor for an interference condition further comprises adapting the access point to monitor for a high ACI rate condition.

5. The method of claim 1, wherein the step of adapting the access point to monitor for an interference condition further comprises adapting the access point to monitor for either a beacons-stuck or Tx-stuck condition.

6. The method of claim 1, wherein the step of providing a desired time threshold further comprises providing an ACI state timeout.

7. The method of claim 1, wherein the step of providing a desired time threshold further comprises providing an NB state timeout.

8. The method of claim 1, wherein the step of adapting the access point to alter an operational characteristic responsive to an occurrence of the interference condition further comprises adapting the access point to reduce the access point's clear channel assessment sensitivity.

9. The method of claim 8, wherein the step of adapting the access point to reduce the access point's clear channel assessment sensitivity further comprises reducing an energy detection parameter.

10. The method of claim 8, wherein the step of adapting the access point to reduce the access point's clear channel assessment sensitivity further comprises increasing a packet detection parameter.

11. The method of claim 1, wherein the step of adapting the access point to alter an operational characteristic responsive to an occurrence of the interference condition further comprises adapting the access point to switch operational mode.

12. The method of claim 11, wherein the step of adapting the access point to switch operational mode further comprises adapting the access point to switch to (b)-only mode.

13. The method of claim 11, wherein the step of adapting the access point to switch operational mode further comprises adapting the access point to switch to a different communication channel.

14. The method of claim 1, wherein the step of providing a desired time threshold further comprises providing a predetermined time threshold.

15. The method of claim 1, wherein the step of providing a desired time threshold further comprises providing a dynamically determined time threshold.

16. The method of claim 4, further comprising the step of aborting ACI packets during an ACI condition.

17. A system for mitigating deleterious interference effects on a wireless LAN system, the system comprising:
a wireless LAN access point;
a first construct within the access point adapted to monitor for a specific interference condition;
a desired time threshold;
a second construct within the access point adapted to alter operation of the access point responsive to an occurrence of the specific interference condition and continue the altered operation until the desired time threshold has passed; and
a third construct adapted to return operation of the access point to an original operational state after the desired time threshold has passed and the interference condition has ended.

18. The system of claim 17, wherein the wireless LAN system comprises an 802.11-based communication system.

19. The system of claim 17, wherein the first construct monitors for a high ACI rate condition.

20. The system of claim 17, wherein the first construct monitors for either a beacons-stuck or Tx-stuck condition.

21. The system of claim 17, wherein the second construct reduces the access point's clear channel assessment sensitivity.

22. The system of claim 21, wherein the second construct reduces an energy detection parameter.

23. The system of claim 21, wherein the second construct increases a packet detection parameter.

24. The system of claim 17, wherein the second construct switches operational mode.

25. The system of claim 24, wherein the second construct switches to (b)-only mode.

26. The system of claim 24, wherein the second construct switches to a different communication channel.
